(19) United States
(12) Patent Application Publication
(10) Pub. No.: US 2006/0168990 A1
(43) Pub. Date: Aug. 3, 2006

(54) DAMPER DEVICE FOR REFRIGERATOR

(76) Inventor: JUNG-BUM PARK, Incheon (KR)

Correspondence Address: PARK LAW FIRM, 3255 WILSHIRE BLVD, SUITE 1110, LOS ANGELES, CA, 90010, US

(21) Appl. No.: 10/906,960

(22) Filed: Mar. 14, 2005

(30) Foreign Application Priority Data
Feb. 1, 2005 (KR) 10-2005-0008967

(51) Int. Cl. B01D 8/00; F25D 17/04

(52) U.S. Cl. 62/408

(57) ABSTRACT

A damper device for a refrigerator has a power transmission structure capable of performing accurate opening/closing operation when a motor is used as the power source for rotating a number of baffles of the refrigerator to open/close a number of cold air passages for a compact overall size. The damper device for a refrigerator includes a frame having openings connected to a cold air passage; baffles; and a driving device to rotate the baffles, wherein the driving device has a motor for generating a driving rotation force, a gear device for transmitting the rotation force from the motor, a first following shaft for receiving the rotation force from the gear device and transmitting it to the first baffle, and a second following shaft connected to the first following shaft via a link mechanism to transmit the rotation force to the second baffle.

### TECHNICAL FIELD

The present invention relates to a damper device for a refrigerator, and more particularly to a damper device for a refrigerator, which has a power transmission structure capable of performing accurate opening/closing operation when a motor is used as the power source for rotating a number of baffles of the refrigerator to open/close a number of cold air passages for a compact overall size.

### BACKGROUND ART

In general, a refrigerator has a damper device installed the cold air passage to maintain the internal temperature of the refrigerator at a preset level by regulating the amount of cold air.

A conventional damper device for a refrigerator includes a frame installed in the cold air passage and provided with an opening, a baffle adapted to open/close the opening of the frame, and a motor for providing a rotation force necessary for opening/closing operation of the baffle.

Recently, some refrigerators have a number of separate chambers including a refrigerating chamber, a freezing chamber, a vegetable chamber, and a chilled chamber, the temperature of which is separated controlled. In addition, some refrigerators have a large chamber and the temperature of each portion of the chamber is separately controlled along the vertical direction. In these types of refrigerators, each chamber or portion has its own cold air passage and a number of damper devices are used to separately control the amount of cold air flowing into each chamber or portion. Alternatively, the cold air passage has two openings and two baffles are used to open/close the baffles (double damper device).

The double damper device includes a frame having a driving device case formed at the center thereof and first and second openings formed on both sides thereof, respectively, a driving device installed in the driving device case and having a reduction gear train and a motor to output a driving rotation force, and first and second baffles rotatably installed on the frame and adapted to receive the rotation force from the motor and the reduction gear train and open/close the first and second openings, respectively.

The first and second openings are connected to the respective cold air passages and the amount of cold air is regulated by the opening/closing operation of the baffles.

However, conventional double damper devices configured as above have a problem in that the driving device transmits the rotation force from the motor to each baffle via the complicated reduction gear train. This makes the structure complicated and increases the number of components and the manufacturing cost.

In addition, the frame has a driving device case positioned at the center thereof and first and second openings positioned on both sides thereof, respectively. This increases the overall width and much internal space of the refrigerator is occupied.

Furthermore, the driving device rotates the first and second baffles by interlocking the reduction gear train, which has a toothed engagement structure, and the structural backlash phenomenon caused by the toothed engagement of the reduction gear train causes the baffles to float relative to the frame. As a result, the degree of sealing against the openings deteriorates and, when the baffles switch from a state wherein they close the openings to a state wherein they open the openings or vice versa, the rotation force cannot be accurately transmitted due to the floating. Consequently, cold air cannot be hermetically sealed and properly circulated inside the refrigerator.

### DISCLOSURE OF THE INVENTION

Therefore, the present invention has been made in view of the above-mentioned problems, and it is an object of the present invention to provide a damper device for refrigerator, wherein the position of a driving device case having a driving device installed therein is modified, the number of internal components is minimized for a compact overall size, and a rotation force can be accurately transmitted from a motor of the driving device to a number of baffles for accurate opening/closing operation of the baffles.

According to an aspect of the present invention, there is provided a damper device for a refrigerator, which includes a frame having a pair of openings connected to a cold air passage; a pair of baffles rotatably installed on the frame to open/close the openings; and a driving device installed on a surface of the frame to rotate the baffles, wherein the driving device has a motor for generating a driving rotation force, a gear device for transmitting the rotation force from the motor, a first following shaft for receiving the rotation force from the gear device and transmitting it to the first baffle, and a second following shaft connected to the first following shaft via a link mechanism to transmit the rotation force to the second baffle.

The gear device is a worm gear device.

The first and second baffles are opened/closed simultaneously.

The link mechanism includes a first link plate formed on the first following shaft, a second link plate formed on the second following shaft, and a link bar for connecting the first and second link plates to each other.

A diaphragm vertically extends from the frame between the baffles and a buffering member is attached to at least one surface of the diaphragm to buffer the contact impact between the baffles and the diaphragm when the baffles are in the maximum opening position.

The buffering member is made up of any one chosen from a group comprising foamed polyurethane, rubber, and soft tape.

The driving device is positioned on any one of the upper and lower portions of the frame.

In accordance with another aspect of the present invention, there is provided a damper device for a refrigerator, which includes a frame having a number of openings connected to a cold air passage; a number of baffles rotatably installed on the frame to open/close the openings; and a driving device installed on a surface of the frame to rotate the baffles, wherein the driving device has a motor for generating a driving rotation force, a gear device for transmitting the rotation force from the motor, a number of following shafts for receiving the rotation force from the gear device and transmitting it to baffles, and a link mechanism for connecting the respective following shafts to transmit the rotation force to the baffles.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a perspective view showing a refrigerator damper according to the present invention when its baffles have completely opened the openings;

FIG. 2 is a top view showing a refrigerator damper according to the present invention when its baffles have partially opened the openings;

FIG. 3 is a top view showing a driving device;

FIG. 4a is a top view showing in brief the rotation of the first and second following shafts connected to the link mechanism when the baffles are in a complete opening position; and

FIG. 4b is a top view showing in brief the rotation of the first and second following shafts connected to the link mechanism when the baffles are in a closing position.

### BEST MODE FOR CARRYING OUT THE INVENTION

Reference will now be made in detail to the preferred embodiments of the present invention.

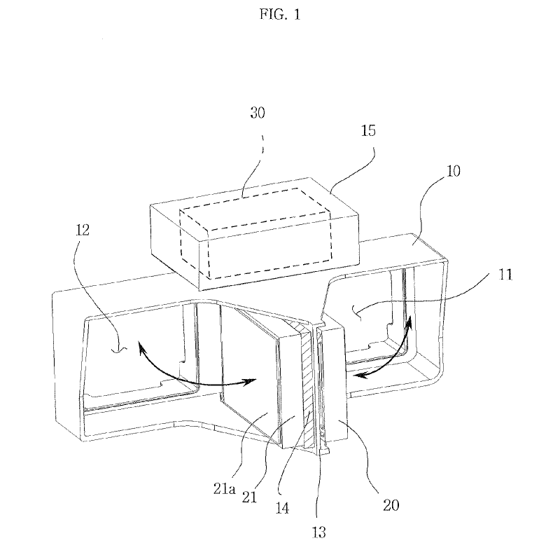

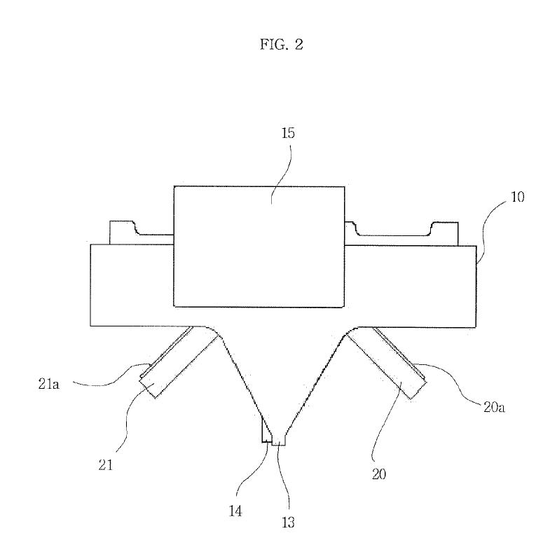

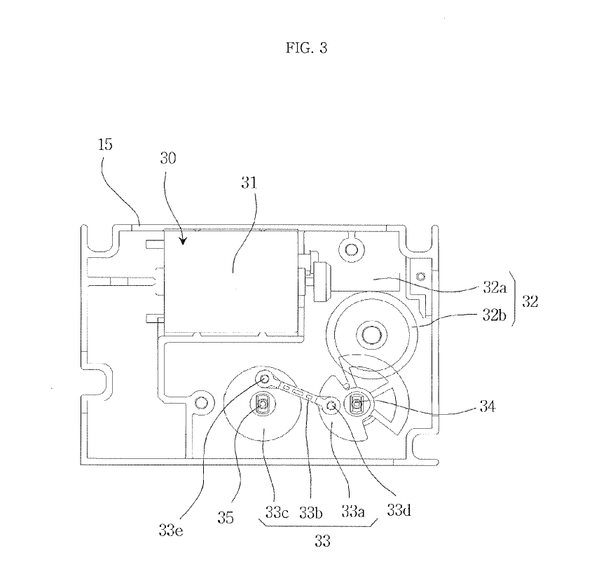

FIG. 1 is a perspective view showing a refrigerator damper according to the present invention when its baffles have completely opened the openings, FIG. 2 is a top view showing a refrigerator damper according to the present invention when its baffles have partially opened the openings, FIG. 3 is a top view showing a driving device.

As shown in FIGS. 1 to 3, the refrigerator damper according to the present invention includes a frame 10 having a pair of openings 11 and 12 connected to a cold air passage of the refrigerator, a pair of baffles 20 and 21 rotatably installed on the frame 10 to open/close the openings 11 and 12, and a driving device 30 installed in a driving device case 15 formed on a side of the frame 10 to rotate the baffles 20 and 21 so that they perform opening/closing operation.

The driving device 30 has a pair of following shafts 34 and 35 connected to the pair of baffles 20 and 21, respectively. The following shafts 34 and 35 are connected to a link mechanism 33 and are rotated together.

The construction of the refrigerator damper will now be described in more detail.

The frame 10 has first and second openings 11 and 12 formed on both sides thereof, respectively, to be connected to a cold air passage and a diaphragm 13 vertically extending from the center thereof in the forward direction to partition the first and second openings 11 and 12. The diaphragm 13 has a buffering member 14 attached to a surface thereof to reduce noise generated when the baffles 20 and 21 are in the complete opening position and collide with the diaphragm 13. The frame 10 has a driving device case 15 positioned on the top thereof. The driving device case 15 may also be positioned beneath the frame 10.

The buffering member 14 is preferably made up of foamed polyurethane, rubber, or soft tape.

The baffles 20 and 21 are adapted to regulate the flow of cold air through the first and second openings 11 and 12 and have a square-shaped structure. A side of the baffles 20 and 21 is rotatably supported on the frame 10 so that they open/close the first and second openings 11 and 12 as they rotate.

The baffles 20 and 21 have elastic sealing members 20a and 21a, respectively, made up of the same material as the buffering member 14 (that is, foamed polyurethane, rubber, or soft tape) to improve the sealing effect of their surface abutting the frame 10 when they close the openings 11 and 12.

As shown in FIG. 3, the driving device 30 includes a motor 31 for generating a driving rotation force, a worm gear device 32 for transmitting the rotation force from the motor 31, a first following shaft 34 for transmitting the rotation force from the worm gear device 32 to the first baffle 20, and a second following shaft 35 connected to the first following shaft 34 via a link mechanism 33 to transmit the rotation force to the second baffle 21.

The first and second following shafts 34 and 35 extend through the bottom surface of the driving device case 15 and are connected to the first and second baffles 20 and 21 to transmit a rotation force.

The worm gear device 32 increases the rotation speed reduction ratio while reducing the number of components and includes a worm 32a fixed to an end of the rotation shaft of the motor 31 and a worm wheel 32b adapted to vertically receive a rotation force from the worm 32a for reduction and gear-engage the first following shaft 34 to transmit the rotation force.

The link mechanism 33 connects the first and second following shafts 34 and 35 to each other in such a manner that, as the first following shaft 34 rotates, the second following shaft 35 rotates together.

The link mechanism 33 includes a first link plate 33a formed on the first following shaft 34, a second link plate 33c formed on the second following shaft 35, and a link bar 32b for connecting the first and second link plates 33a and 33c to each other.

The interconnection between the first and second following shafts 34 and 35 via the link mechanism 33 will now be described in more detail.

The first and second baffles 20 and 21 are symmetrical to each other about the diaphragm 13 of the frame 10 (refer to FIG. 1) and are rotated in the opposite directions so that they can be opened/closed simultaneously.

As shown in FIG. 3, an end of the link bar 32b is connected to the left portion (first connection point 33d) of the first link plate 33a of the first following shaft 34 and the other end thereof is connected to the upper portion (second connection point 33e) of the second link plate 33c of the second following shaft 35.

The distance between the first connection point 33d, to which the link bar 32b and the first link plate 33a are connected, and the center of the first following shaft 34 is the same as the distance from the second connection point 33e, to which the link bar 32b and the second link plate 33c are connected, and the center of the second following shaft 35.

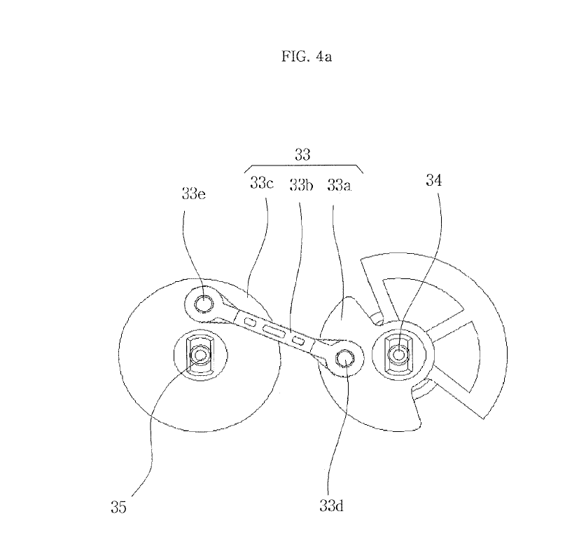

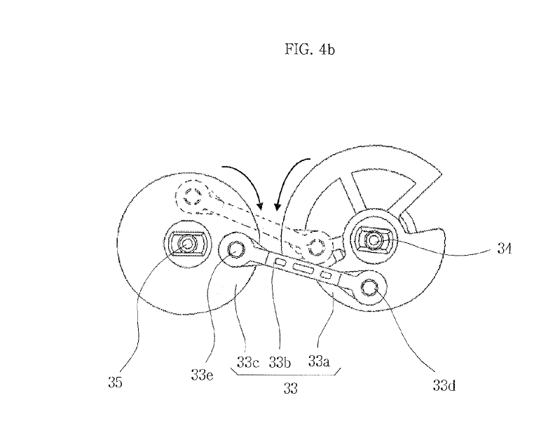

The opening/closing operation of the first and second baffles 20 and 21 as the first and second following shafts 34 and 35 rotate together by means of the link mechanism 33 will now be described with reference to FIGS. 4a and 4b.

FIG. 4a is a top view showing in brief the rotation of the first and second following shafts connected to the link mechanism when the baffles are in a complete opening position and FIG. 4b is a top view showing in brief the rotation of the first and second following shafts connected to the link mechanism when the baffles are in a closing position.

When the first and second baffles 20 and 21 are in a complete opening position as shown in FIG. 4a, the first connection point 33d is positioned on the left side of the first link plate 33a and the second connection point 33e is positioned on the upper side of the second link plate 33c.

When the first following shaft 34 is rotated 90° in the counterclockwise direction from the state shown in FIG. 4a, the first connection point 33d is positioned on the lower side and the second connection point 33e is positioned on the left side of the second link plate 33c, as shown in FIG. 4b. Particularly, the second following shaft 35 is rotated 90° in the clockwise direction under the interlocking of the link bar 32b as the first following shaft 34 is rotated 90° in the counterclockwise direction. As a result, the first baffle 20 connected to the first following shaft 34 is rotated 90° in the counterclockwise direction and closes the first opening 11 and the second baffle 21 connected to the second following shaft 35 is rotated 90° in the clockwise direction and closes the second opening 12.

When the first and second following shafts 34 and 35 rotate and the first and second baffles 20 and 21 are in the closing position as shown in FIG. 4b, the driving device 30 rotates in the opposite direction and the first and second following shafts 34 and 35 connected to the link mechanism 33, as shown in FIG. 4a, rotate in the opposite direction. The first and second baffles 20 and 21 then perform opening operation.

The first and second following shafts 35 and 35 are interlocked by the link mechanism 33 for opening/closing operation of the first and second baffles 20 and 21. Consequently, floating among power transmission components is minimized and more accurate opening/closing operation of the first and second baffles 20 and 21 is guaranteed.

Such opening/closing operation of the first and second baffles 20 and 21 under interlocking by the link mechanism 33 suppresses the backlash phenomenon occurring in the convention reduction gear train and prevents the baffles from floating during opening/closing operation.

Although the present invention has been described with reference to an illustrative example wherein two openings are formed in the frame connected to the cold air passage of the refrigerator, the link mechanism can also be applied to a case wherein the frame has three or more openings for more accurate opening/closing operation of the baffles.

In the case of three frames and three baffles, for example, the driving device has three following shafts connected to the respective baffles and interlocked by a link mechanism to transmit the rotation force from the driving device for more accurate opening/closing operation of the baffles.

As mentioned above, the inventive damper device for a refrigerator has modified the position of the driving device case, in which the driving device is installed, to the upper or lower portion of the frame and has a minimum number of power transmission components by means of the worm gear device and the link mechanism for a compact size. This increases the efficiency in space utilization of the refrigerator and reduces the manufacturing cost.

When the rotation force generated by the motor of the driving device is transmitted to the respective baffles, the rotation force is transmitted to the following shafts by the link mechanism for opening/closing operation of the baffles. This minimizes the floating among coupled components and prevents the baffles from floating. Consequently, the baffles can perform opening/closing operation more accurately, the cold air within the refrigerator is not lost but is circulated uniformly, and the efficiency of the refrigerator improves further.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

What is claimed is:

1. A damper device for a refrigerator, comprising:
a frame having a pair of openings connected to a cold air passage;
a pair of baffles rotatably installed on the frame to open/close the openings; and
a driving device installed on a surface of the frame to rotate the baffles, wherein
the driving device has a motor for generating a driving rotation force, a gear device for transmitting the rotation force from the motor, a first following shaft for receiving the rotation force from the gear device and transmitting it to the first baffle, and a second following shaft connected to the first following shaft via a link mechanism to transmit the rotation force to the second baffle.

2. The damper device for a refrigerator as claimed in claim 1, wherein the gear device is a worm gear device.

3. The damper device for a refrigerator as claimed in claim 1, wherein the first and second baffles are opened/closed simultaneously.

4. The damper device for a refrigerator as claimed in claim 1, wherein the link mechanism comprises a first link plate formed on the first following shaft, a second link plate formed on the second following shaft, and a link bar for connecting the first and second link plates to each other.

5. The damper device for a refrigerator as claimed in claim 1, wherein a diaphragm vertically extends from the frame between the baffles and a buffering member is attached to at least one surface of the diaphragm to buffer the contact impact between the baffles and the diaphragm when the baffles are in the maximum opening position.

6. The damper device for a refrigerator as claimed in claim 5, wherein the buffering member is made up of any one chosen from a group comprising foamed polyurethane, rubber, and soft tape.

7. The damper device for a refrigerator as claimed in claim 1, wherein the driving device is positioned on any one of the upper and lower portions of the frame.

8. A damper device for a refrigerator comprising:
a frame having a number of openings connected to a cold air passage;
a number of baffles rotatably installed on the frame to open/close the openings; and
a driving device installed on a surface of the frame to rotate the baffles, wherein
the driving device has a motor for generating a driving rotation force, a gear device for transmitting the rotation force from the motor, a number of following shafts for receiving the rotation force from the gear device and transmitting it to baffles, and a link mechanism for connecting the respective following shafts to transmit the rotation force to the baffles.
